(19) United States
(12) Patent Application Publication
(10) Pub. No.: US 2012/0132648 A1
(43) Pub. Date: May 31, 2012

(54) INDUCTION HEATING UNIT FOR HAIR ROLLERS

(76) Inventor: David Ingleby-Oddy, Truro (GB)

(21) Appl. No.: 13/261,172

(22) PCT Filed: Aug. 5, 2010
(86) PCT No.: PCT/GB2010/051292

§ 371 Date: Feb. 3, 2012

(30) Foreign Application Priority Data
Aug. 5, 2009 (GB) 0913704.3
Mar. 18, 2010 (GB) 1004503.7
Jun. 8, 2010 (GB) 1009592.5

(51) Int. Cl. H05B 6/10

(52) U.S. Cl. 219/635

(57) ABSTRACT

An induction heating unit for inductively heating hair rollers has a base (2) which is capable of resting stably on a horizontal surface and a well (4) for receiving the hair roller. The well has a bottom wall and a side wall and is inclined relative to the base (2). A coil of wire (18) is disposed around the perimeter of the well (4), and an electronic controller is arranged to supply a varying current to the coil by means of pulses applied to a semiconductor switch. Different size rollers will always occupy a position against the side wall at the lowest part of the well. A sensor (21) is disposed in the lowest part of the well adjacent to the side wall to monitor the temperature or weight of the rollers and vary the amount of heating for different sizes of roller. The size of the roller may also be determined by applying an electrical pulse to the coil (18) and monitoring the ringing effect produced in the coil.

### TECHNICAL FIELD OF THE INVENTION

This invention relates to an induction heating unit which is intended for heating hair rollers by electromagnetic induction.

### BACKGROUND

Induction heating is a process by which electrically conducting objects, usually of metal, are heated by placing the object in the field of an induction coil fed with a high-frequency pulsed or alternating current. Electromagnetic induction causes eddy currents to be generated within the metal which undergoes Joule heating due to its electrical resistance. In materials that have significant relative permeability, heat may also be generated by magnetic hysteresis losses.

The use of electromagnetic induction to heat rollers for hair styling is already known and provides several significant advantages over conduction heating, principally a very short warm-up time and avoidance of residual high temperatures in the heating unit.

U.S. Pat. No. 4,499,355 discloses an induction heating unit intended to heat hair rollers which have a moulded plastic cylindrical body and a high permeability cylindrical metal core. The induction heating unit has a vertically disposed non-conducting well for receiving the roller, with 20 to 60 turns of insulated wire coiled around its outer perimeter. The coil is powered by an oscillator producing AC at a frequency of between 1 and 100 kHz, and the temperature of the rollers is controlled using a magnetic self-limiting system. This is accomplished by providing a low Curie point alloy insert in the bottom end of the rollers. When the roller is placed in the well a spring-loaded magnet is attracted to the insert causing a lever to activate a switch which completes the circuit allowing the current to flow into the heating coil and causing the roller to heat up. When the alloy insert reaches its Curie point the alloy loses its magnetic properties and the magnet moves away turning off the switch. The heated roller can then be removed ready for use.

Modern hair styling often requires the use of rollers of various diameters which must be heated quickly to an optimum target temperature. The known heating unit described above is only capable of heating one size of roller, and the target temperature is essentially fixed at the Curie point, and not very accurately.

JP 5 121 152 A discloses an induction heating unit for hair rollers which determines the size of a roller and adjusts the amount of heating by measuring the current flowing in the induction heating coil during the heating process. Tight coupling between the hair roller and the heating coil is maintained during the heating process by placing the roller around the outside of the heating coil. In JP 6 327 513 A the heating coil is again located inside the roller, but in this case the size of the roller is determined by physically measuring its width.

A major drawback with all the existing induction heating units is that the accuracy of the heating control depends upon accurate positioning of the roller. In a busy hair salon the throughput of rollers is very high, and the existing units all tend to be slow and awkward to use.

The present invention seeks to provide a new and inventive form of induction heating unit that is capable of quickly heating different sized rollers to an accurately controlled target temperature.

### SUMMARY OF THE INVENTION

The present invention proposes an induction heating unit for inductively heating hair rollers, the unit having a base which is capable of resting stably on a horizontal surface, a well for receiving a roller, a coil of wire disposed around the well, and an electronic controller arranged to supply a varying current to the coil to inductively heat the roller,
in which the well is inclined relative to a horizontal surface upon which the base is supported and includes sensing means arranged to monitor a roller placed in the well and provide a signal which enables the controller to adjust the amount of heating in accordance with the size of the roller.

The use of an inclined well allows automatic accurate positioning of the rollers without conscious effort by the user, and facilitates the use of sensing means which are not position-critical, examples of which will be described herein.

In one embodiment the sensing means may be arranged to monitor the temperature of a roller placed in the well, and the heating process may be continued until the roller attains the required temperature. In a preferred embodiment, the sensing means may be arranged to monitor the weight of a roller placed in the well. The amount of heating (time and/or power) can then be adjusted according to the size (weight) of the roller. In a second preferred embodiment the size of the roller may be determined by applying an electrical pulse to the coil and monitoring the ringing effect which is produced in the presence of a metallic body.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a general view of an induction heating unit for heating hair rollers in accordance with the invention;

FIG. 2 is a vertical section through the induction heating unit;

FIG. 3 is an exploded side view of the heating unit;

FIG. 4 is a block circuit diagram of the induction heating unit; and

FIG. 5 is a graph showing the heating characteristics of the unit being used to heat a small hair roller;

FIG. 6 is a similar graph showing the heating characteristics for a large hair roller;

FIG. 7 is a block circuit diagram of a modified induction heating unit; and

FIG. 8 is a flow diagram showing the operation of another modified form of the induction heating unit.

### DETAILED DESCRIPTION OF THE DRAWINGS

The drawings show an induction heating unit for inductively heating hair rollers which have a cylindrical ferromagnetic metal core open at the bottom end. Since rollers of this general structure are already known, e.g. from U.S. Pat. No. 4,499,355, they will not be described further herein.

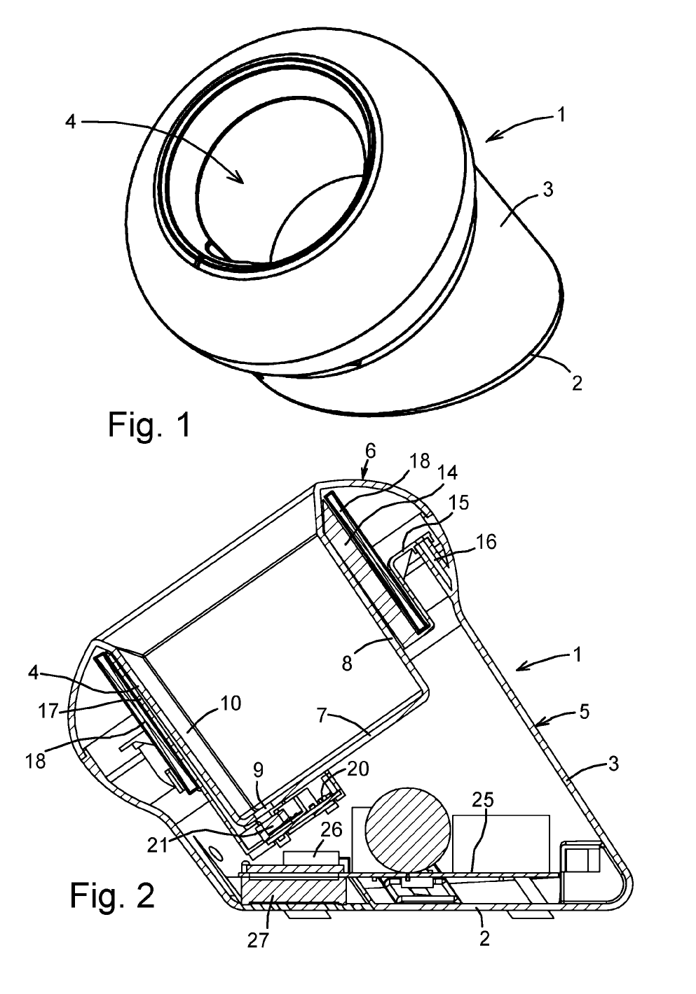

Referring firstly to FIG. 1, the unit includes an outer housing 1 having a base 2 which is capable of resting stably on a flat surface, surrounded by a circular side wall 3, and the upper end of the housing incorporates a central well 4 for receiving the hair rollers. The axis the side wall 3 and the well 4 is tilted towards the front of the unit, so that the well is inclined relative to the base 2. Thus, when a hair roller is placed into the well 4 with its open end downwards it will always rest against the lowest side of the well.

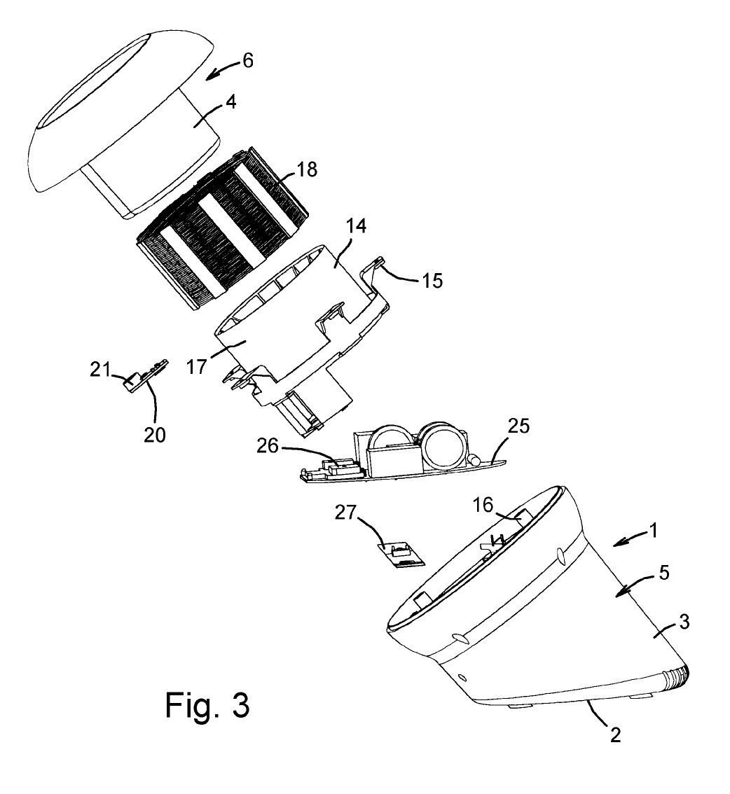

Referring to FIGS. 2 and 3, the housing 1 includes a bottom moulding 5, which incorporates the base 2 and side wall 3, and a top moulding 6 which incorporates the well 4. The sectional view shows that the well 4 includes a circular bottom wall 7 and a cylindrical inner wall 8, and the bottom wall has an aperture 9 adjacent to the side wall 3 at the lowest region which is closest to the base 2. The inner wall 8 is also formed with a shallow axially extending channel 10 adjacent to the aperture 9, which assists in ensuring that the hair roller will always tend to rest in the same position at the lower part of the well 4 irrespective of the rollers diameter. An inner moulding 14 is mounted within the upper end of the bottom moulding 5, affixed by screws inserted through flanges 15 into co-operating sockets 16 formed in the bottom moulding. The inner moulding includes a cylindrical outer wall 17 closely surrounding the well 4, which in turn supports a coil of wire 18 disposed around the perimeter of the well 4. The inner moulding 14 also supports an auxiliary PCB (printed circuit board) 20 which carries a thermal sensor 21 in close registration with the aperture 9. The thermal sensor is preferably a thermopile. A thermopile is an electronic device that converts thermal energy into electrical energy. It is composed of thermocouples connected in series, or less commonly in parallel. Thermopiles do not measure absolute temperature, but generate an output voltage proportional to a local temperature difference or temperature gradient. In this case the thermopile monitors the temperature difference between the inside of the hair roller, as monitored in the infrared spectrum through the open bottom end of the roller, and the inside of the housing 1. The lower part of the bottom moulding 5 carries a main PCB 25 which supports an electronic controller, a power supply and various other electronic components including a semiconductor switch 26. A fan 27 is mounted between the base 2 and the PCB 25 to draw air into the housing 1 for general cooling, and particularly to cool the semiconductor switch 26 below which the fan is mounted.

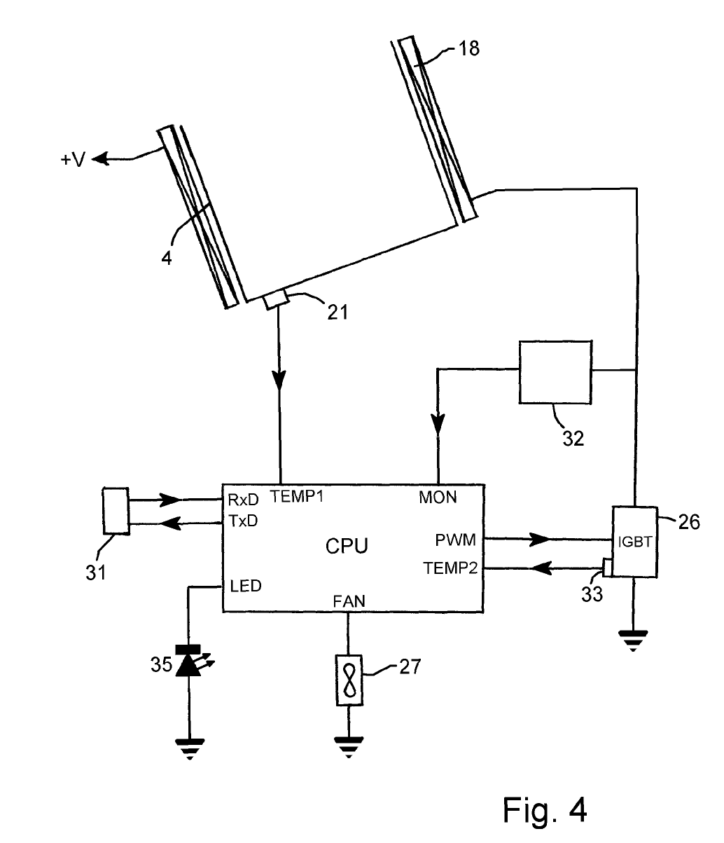

FIG. 4 shows the main components of the electronic control circuit which is responsible for operating the induction heating unit. The central control unit is a microprocessor 30 which can be externally programmed via a serial port 31. One end of the induction heating coil 18 is supplied with a relatively high DC voltage (typically 250 to 300 volts) while the opposite end goes to the semiconductor switch 26. A preferred form of switch 26 is an insulated gate bipolar transistor, or IGBT, which is a three-terminal power semiconductor device, noted for high efficiency and fast switching. The IGBT combines the simple gate-drive characteristics of the MOSFETs with the high-current and low-saturation-voltage capability of bipolar transistors by combining an isolated gate FET for the control input, and a bipolar power transistor as a switch, in a single device. The device is driven by the controller 30 using pulse width modulation, or PWM, to vary the on/off ratio of the coil and hence its power consumption. The controller can monitor the voltage appearing across the coil 18 by means of a monitor circuit 32, and can also monitor the temperature of the rollers via the sensor 21, as described. A further temperature sensor 33 is thermally bonded to the switch 26 to allow the controller to monitor the operating temperature of the switch, and the controller also controls the fan 27. The controller is also provided with a visible status indicator in the form of an LED 35

When the unit is idle the controller 30 periodically “pings” the coil 18, e.g. every 2 seconds, by applying a short pulse to the control input of switch 26. The LED 35 remains off during this process. If no roller is present no resonance will be detected by the monitor circuit 32, but if a heating roller is present the controller will detect a significant resonance in the coil. When a roller is present the controller applies a series of pulses to the switch 26 so that a pulsed current flows in the coil 18 causing the roller to heat up by electromagnetic induction. This phase is indicated by rapid flashing of the LED 35.

During the heating process the internal temperature of the roller is monitored by the sensor 21, and when the roller has reached a target temperature which has been programmed into the controller (say 100° C.) the pulses cease to stop the heating process and the LED 35 illuminates continuously to indicate that the roller is up to temperature and ready for use. The coil may be “pinged” from time to time to check whether the roller has been removed. Also, the temperature sensor 21 can continue to monitor the temperature of the roller, and if the roller starts to cool off a further heating cycle may be initiated.

If at any time the temperature of the unit starts to rise, and specifically the operating temperature of the switch 26 as monitored by sensor 33, the controller turns on the fan 27 until the temperature returns to a safe operating level.

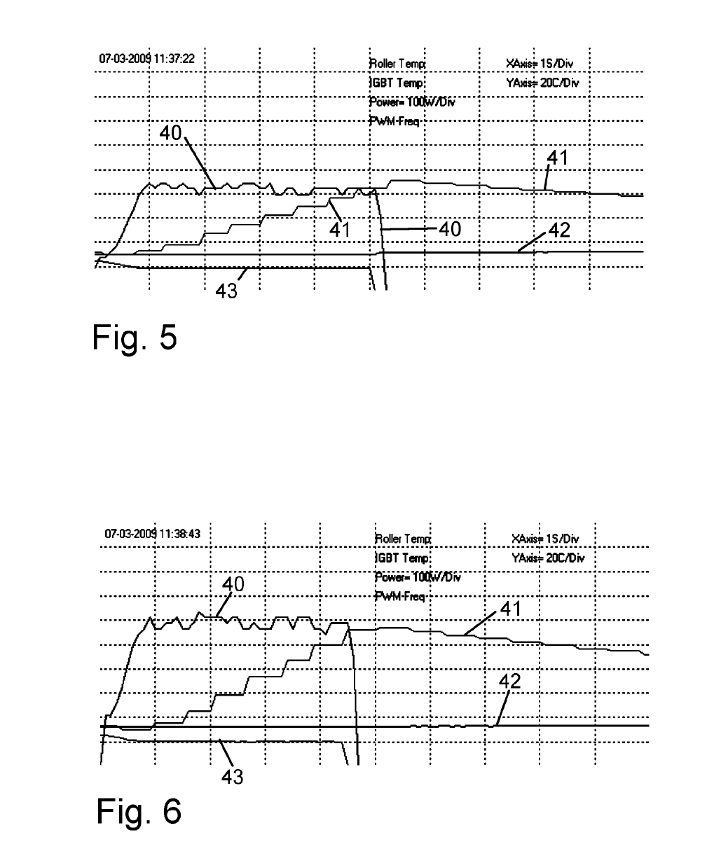

Different size rollers will always occupy the same position at the lower part of the well 4, and the inside of the rollers will always be “visible” to the sensor 21. Furthermore, the unit always ensures that the roller attains a suitable operating temperature irrespective of its physical dimensions. FIG. 5 shows a typical heating cycle for a small roller which starts at ambient temperature. Trace 40 shows the power applied to the coil 18, trace 41 shows the temperature of the roller as monitored by the sensor 21, trace 42 is the temperature of the switch 26, and trace 43 is the PWM frequency applied to the switch 26. It will be seen that once the roller reaches the desired temperature the PWM pulses cease and the power applied to the coil 18 falls to zero. The roller then begins slow cooling towards ambient temperature. In comparison FIG. 6 shows, on the same scale, the same traces for a large hair roller heated from ambient. It will be seen that the heating cycle is shorter, but the power consumption is greater and the roller attains a slightly higher temperature due to its greater thermal mass. Between these two extremes the heating is remarkably consistent and the heating process is essentially self-regulating.

The monitor circuit 32 can monitor the voltage applied to the coil 18, so that the controller 30 is able to calculate the power supplied to the coil. The controller uses PWM to adjust the period, or frequency, of the pulses applied to the switch 26, and hence to the coil 18, so that the power delivered to the coil can be accurately controlled.

Various parameters are externally programmable, as follows:
The rate at which the coil is “pinged” to detect a roller.
The target temperature at which the unit stops heating the rollers (e.g. 50 to 200° C.).
Permitted roller cooling temperature. If the roller falls below this temperature the status LED is extinguished and the roller must be removed and re-inserted to initiate a further heating cycle.
Roller heating timeout period. If the roller does not reach the target temperature within this timeout period the heating is terminated and the status LED indicates a fault condition (slow flashing). This may, for example, be due to the roller not being seated correctly in the well, or the temperature sensor being dirty or obscured.
Heating power delivered to the roller.
Roller detection threshold.
Unit shutdown temperature, i.e. the temperature at which the unit will shut down if the sensor 33 indicates that the switch 26 is in danger of overheating.
Fan startup temperature.
Status LED flashing period during heating (fast).
Status LED error flashing period (slow).

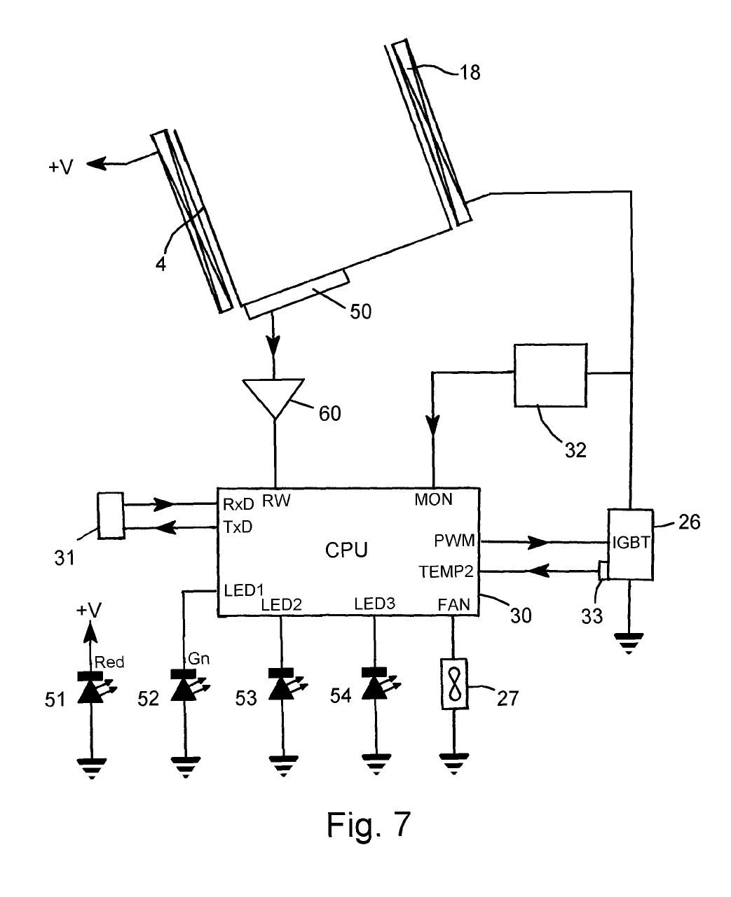

Although the use of a thermal sensor 21 in the lower part of the well 4 provides a reliable way of detecting when a roller has reached the desired working temperature, other methods are possible. In FIG. 7, the thermal sensor is replaced by a load cell 50, which is mounted in the bottom wall 7 at the lowest part of the well 4, adjacent to the side wall 3. A load cell is an electronic transducer which comprises one or more strain gauges. The weight of a hair roller placed into the well 4 deforms the strain gauges which convert the amount of deformation into electrical signals. The electrical output is typically in the order of a few millivolts and is amplified by instrumentation amplifier 60 before being sent to microprocessor 30, which uses a known algorithm to calculate the weight of the roller.

One end of the induction heating coil 18 is supplied with a DC voltage (typically 250 to 300 volts) and the opposite end goes to a semiconductor switch 26 (an IGBT) which is driven by the controller 30 using PWM. The controller 30 can monitor the voltage appearing across the coil 18 by means of a monitor circuit 32, and can monitor the operating temperature of the IGBT using a temperature sensor 33. The controller may also control an optional cooling fan 27 and is provided with a bank of LEDs 51-54 which act as visible status indicators. Red LED 51 is a power indicator which lights when the unit is on. Green LED 52 indicates the operating status of the unit, LED 53 lights when the temperature of the unit is low (as detected by the IGBT sensor 33), and LED 54 lights when the IGBT temperature is high.

When there is no roller in the well the green LED 52 is off. When the controller 30 detects that a heating roller is inserted into the well it calculates the weight of the roller from load cell 50 and uses a lookup table or performs a calculation to determine the heating time which is required to heat the roller to a programmed operating temperature (say 100° C.). The controller applies a series of pulses to the switch 26 so that a pulsed current flows in the coil 18 causing the roller to heat up. This phase is indicated by rapid flashing of the LED 52.

When the roller has been heated for the appropriate time the controller stops the heating process and the LED 52 illuminates continuously to indicate that the roller is ready for use. When the load cell detects that the roller has been removed LED 52 goes out.

The controller may operate such that, if the roller is not removed after a predetermined period, a further short heating cycle will commence (again adjusted to the weight of the roller) to keep the roller up to the required temperature.

If at any time the operating temperature of the switch 26 starts to rise, as monitored by sensor 33, the controller may turns on the fan 27 (if provided) or inhibit further operation of the unit until the temperature returns to a safe operating level.

The unit always ensures that the roller attains a suitable operating temperature for its size and weight. A small roller of relatively low weight may be heated at low power for a relatively long period or at high power for a shorter period. On the other hand, a heavy roller may be heated for a short period at higher power. By monitoring the voltage at the coil 18 the monitor circuit 32 allows the controller 30 to determine the power supplied to the coil. The controller uses PWM to adjust the period or frequency of the pulses applied to the switch 26 so that the power delivered to the coil can be accurately controlled.

The controller 30 could be externally programmed via an optional serial port 31.

A significant advantage of determining the weight of the roller prior to heating is that this provides a way of screening metal items inserted into the well before the heating commences. The controller can be programmed to heat rollers of suitable weight, but if the weight of the inserted item falls outside the programmed parameters (e.g. a bunch of keys) no heating will occur. Thus, a typical unit may accept weights corresponding to rollers having an outside diameter of say 20 mm, 27 mm, 37 mm, 45 mm etc. and reject other weights falling outside the programmed tolerances.

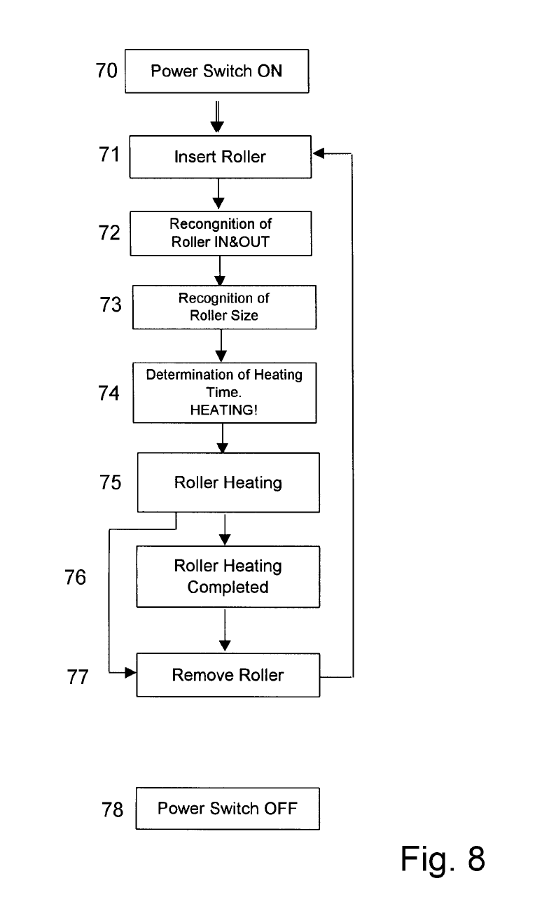

A third method of determining the amount of heating to be applied to a roller, without using a load cell, makes use of the “pinging” process described above. In this embodiment the load cell 50 and amplifier 60 of FIG. 7 may be replaced with a microswitch or other means for detecting the presence of a roller. The operation of such a modified heating unit will now be described with reference to the flow diagram of FIG. 8. In this embodiment the controller 30 also drives a small sounder in addition to LEDs, to emit an audible beeping sound.

At step 70 the power is switched on, which may be signalled to the user by illumination of a power LED accompanied by a beeping sound. A roller is inserted, step 71, having one of the roller sizes which the unit is pre-programmed to accept. This triggers the microswitch, step 72, which sends a “roller in” signal to the controller 30, which then initiates a roller recognition process, step 73, by sending a short single pulse to the induction coil via the semiconductor switch 26. This produces a ringing effect in the coil which is proportional to the size of the steel body present in the well, i.e. the larger the body the longer the oscillations will take to die away. The duration of the ringing effect, detected via the monitoring circuit 32, can therefore be used to accurately determine the size of the roller. Provided the measured time period corresponds to one of the accepted roller sizes, the controller looks up the heating time, power etc. for the detected roller size, step 74, and commences the heating process.

The roller size may be signalled to the user, e.g. by beeping once for a small roller, twice for a medium sized roller etc. During the heating process a green LED may flash. If the microswitch signals that the roller is removed before the heating period ends, step 77, the unit returns to step 71 to await a new roller, but if the heating period is completed, step 76, the green LED will light continuously and the unit may beep once to signal that the roller is ready for use. Removal of the heated roller at step 76, signalled by the microswitch, again returns the program flow to step 71.

Turning off the power shuts the unit down, step 78.

Inclination of the well is important in each embodiment because it ensures that accurate and consistent readings of temperature, or weight are obtained. When the ringing effect is used to determine roller size, the inclination of the well ensures that the roller is always detected, and also ensures more accurate determination of roller size.

Whilst the above description places emphasis on the areas which are believed to be new and addresses specific problems which have been identified, it is intended that the features disclosed herein may be used in any combination which is capable of providing a new and useful advance in the art.

1. An induction heating unit for inductively heating hair rollers, the unit having a base (2) which is capable of resting stably on a horizontal surface, a well (4) for receiving a roller, a coil of wire (18) disposed around the well, and an electronic controller (30) arranged to supply a varying current to the coil to inductively heat the roller,
in which the well (4) is inclined relative to a horizontal surface upon which the base (2) is supported and includes sensing means (21; 50; 18) arranged to monitor a roller placed in the well and provide a signal which enables the controller to adjust the amount of heating in accordance with the size of the roller.

2. An induction heating unit according to claim 1 in which the sensing means is arranged to monitor the temperature of a roller placed in the well.

3. An induction heating unit according to claim 1 in which the sensing means is arranged to determine the size of a roller placed in the well.

4. An induction heating unit according to claim 3 in which the electronic controller is arranged to vary the duration of a heating period in which power is supplied to the coil, depending on the size of a roller as signalled by the sensing means.

5. An induction heating unit according to claim 3 in which the electronic controller is arranged to control the power supplied to the coil for the duration of a heating period, according to the size of a roller as signalled by the sensing means.

6. An induction heating unit according to claim 3 in which the sensing means is arranged to determine the size of the roller by direct measurement of its weight.

7. An induction heating unit according to claim 3 in which the sensing means is arranged to determine the size of the roller by applying an electrical pulse to the coil and monitoring any ringing effect produced in the coil.

8. An induction heating unit according to claim 7 in which the sensing means is arranged to determine the size of the roller by monitoring the duration of the ringing effect.

9. An induction heating unit according to claim 7 which includes a microswitch or other means for detecting the presence of a roller in the well.

10. An induction heating unit according to claim 3 in which the electronic controller heats only rollers which fall within predetermined size parameters.

11. An induction heating unit according to claim 1 in which the well includes a bottom wall (7) and a side wall (8) which incorporates a roller-positioning structure (10).

12. An induction heating unit according to claim 11 in which the roller-positioning structure comprises a channel which extends substantially perpendicular to the bottom wall of the well.

13. An induction heating unit according to claim 1 in which the electronic controller incorporates a semiconductor switch (26) which controls the power supplied to the coil.

14. An induction heating unit according to claim 13 in which the semiconductor switch is an insulated gate bipolar transistor.

15. An induction heating unit according to claim 14 in which the electronic controller supplies pulses to the semiconductor switch and the electronic controller is arranged to control the power supplied to the coil using pulse width modulation.
